(19) United States
(12) Patent Application Publication
(10) Pub. No.: US 2025/0035874 A1
(43) Pub. Date: Jan. 30, 2025

(54) Rail Arrangement, Carrier Arrangement and Fiber-Optic Distribution System

(71) Applicant: Rosenberger-OSI GmbH & Co. OHG, Augsburg (DE)

(72) Inventors: Harald Mayr, Augsburg (DE); Stephanie Jaeger, Augsburg (DE); Thomas True, Augsburg (DE); Nina Simmerlein, Augsburg (DE); Danny Heimer, Augsburg (DE); Luis Ernesto Bruecher Bender, Augsburg (DE); Benjamin Weigand, Augsburg (DE); Daniel Koerner, Augsburg (DE); Stephan Morenz, Augsburg (DE)

(21) Appl. No.: 18/782,548

(22) Filed: Jul. 24, 2024

(30) Foreign Application Priority Data
Jul. 28, 2023 (EP) 23 188 313.3

(51) Int. Cl. G02B 6/44

(52) U.S. Cl. CPC G02B 6/4455; G02B 6/44526

(57) ABSTRACT

A rail-arrangement having a first mounting rail and a spaced apart second mounting rail for receiving carrier units for fibre-optic components, in particular for patch panels. The first and second mounting rails each extend over multiple discrete height levels (H₁, H₂, H₃), to receive and to distribute the received carrier units. Each mounting rail has at least one primary linear guide at each height level (H₁, H₂, H₃), to guide the received carrier unit parallel to a longitudinal axis (L) of the mounting rail. Each mounting rail has, at at leas one height level (H₁, H₂, H₃), bearing surfaces for the primary linear guide and/or for the received carrier unit. The bearing surfaces are spaced apart from one another along the longitudinal axis (L) of the mounting rails.

The invention relates to a rail arrangement for receiving multiple carrier units for fibre-optic components, in particular for patch panels, having a first mounting rail and a separate second mounting rail, according to the preamble of claim 1.

The invention also relates to a carrier arrangement, having multiple carrier units, in particular patch panels, and a rail arrangement for the carrier units.

The Invention also relates to a fibre-optic distribution system, having a distribution frame and at least one carrier arrangement.

In computing centres, carrier units, in particular individual trays up to what are referred to as patch panels are sometimes used for producing and distributing data connections, for example via network cables, telephone cables or glass fibre cables. Such a patch panel generally comprises at least one interface having a certain number of terminals or plug connectors which are either individual or grouped into cassettes, in practice, multiple patch panels are often installed at different height positions or height levels in a joint distribution frame (also referred to as a “rack”).

For reasons of accessibility to the interfaces of the patch panel for a service engineer, the patch panels or trays are often capable of being pulled out of the distribution frame as required and, for this purpose, are fastened in the distribution frame together with a correspondingly designed carrier housing (“chassis”), as described, for example, in US 2022/0236510 A1. The carrier housing is rigidly mounted on the distribution frame and has suitable linear pull-out mechanisms for the trays. In order to further increase the connection density, multiple patch panels are generally arranged in a joint carrier housing.

For reasons of standardization endeavors and as high a degree of modularity as possible, only a limited number of height variants are provided for such carrier housings. Furthermore, the carrier housings can be mounted in the distribution frame only at a discrete spacing—as a multiple of what is referred to as a rack unit (U). Arbitrary height scalability is not possible, and therefore storage space in the distribution frame can often not be optimally used. Furthermore, the diversity of configurations is limited and the generally closed carrier housings also provide only restricted access to the patch panels from the rear side and from above.

Against the background of more effectively utilizing the storage space in a distribution frame, whilst simultaneously providing good accessability for a service engineer, it has proven to be advantageous, for receiving fibre-optic components, for mounting rails which are independent of one another to be arranged opposite one another in the distribution frame, with corresponding bearing surfaces for the individual carrier units or patch panels. Such a system is disclosed, for example, in WO 2023/114256 A1.

In practice, however, it has been shown that the producibility of such a rail arrangement can be comparatively complex and therefore cost-intensive. Furthermore, the mechanical stability for the mounting and guiding of the patch panels in the known solutions is not sufficiently provided for all applications, in particular not over the full insertion and pull-out length of the patch panels along the mounting rails. It can sometimes be the case that the patch panels tilt transversely with respect to the pull-out direction.

In view of the known prior art, it is the object of the present invention to provide a rail arrangement for receiving multiple carrier units for fibre-optic components, by means of which the storage space in a distribution frame is able to be effectively utilized, whilst preferably providing economical producibility of the individual mounting rails and higher mechanical stability.

The present invention is also based on the object of providing an improved carrier arrangement and an improved fibre-optic distribution system, with higher connection density, preferably economical producibility and higher mechanical stability.

The object is achieved, for the rail arrangement, by means of the features specified in claim 1. The object is achieved with regard to the carrier arrangement by means of the features of claim 13 and with regard to the fibre-optic distribution system by claim 15.

The dependent claims and the features described below concern advantageous embodiments and variants of the invention.

A rail arrangement for receiving multiple carrier units for fibre-optic components, in particular for patch panels, having a first mounting rail and a separate second mounting rail is provided. The mounting rails are spaced apart from one another and each extend integrally or monolithically over multiple discrete height levels, in order to receive the carrier units between them so as to be distributed among the height levels.

The carrier unit preferably has at least one fibre-optic component (or at least offers the possibility of receiving a fibre-optic component) and can be movably or non-movably or rigidly received between the mounting rails. The rail arrangement can in particular be designed to movably, in particular translationally, guide the carrier unit along at least one degree of freedom (in particular along at least one translational degree of freedom).

The rail arrangement can fundamentally be suitable for all known and future carrier units. The invention can particularly advantageously be suitable for use with optical trays or patch panels, possibly also for use with optical-electrical trays or patch panels. A tray or patch panel includes optical and/or electrical distribution technology and can have, for example, individual fibre-optic and/or electrical modules or cassettes, individual fibre-optic and/or electrical plug connectors (in particular sockets), devices for storing fibre-optic and/or electrical conductors and lines or other optical and/or electrical components. The carrier unit can also be designed only for purely receiving or depositing/storing and/or for splicing lines. Even dummy carrier units or dummy patch panels can be provided, for example having front plates which are intended exclusively to meet an informative purpose, such as labeling panels, or to be in the form of spacers.

The “first mounting rail” and the “second mounting rail” are also sometimes jointly referred to below as “mounting rails”.

It is preferably provided that the mounting rails of the rail arrangement are components which are independent of one another and which, even in the mounted state, are not connected to one another—apart from the joint connection to the carrier unit and the joint connection to the distribution frame. In particular, additional connecting struts or connecting plates between the two mounting rails of a joint rail arrangement can be dispensed with.

The mounting rails can be formed from a metal component or can at least have metallic components. For example, the mounting rails can have formed sheet metal parts or be designed as formed sheet metal parts and be produced for example in the context of a stamping and bending process. Among other things, the production of the mounting rails in the context of a stamping and bending process can be very well suited to cost-effective production in the context of mass production.

However, it is also possible for the mounting rails to be formed from a plastic or to at least have plastic components. The features of the mounting rails can for example also be produced cost-effectively and with a high degree of accuracy and low component weight in the context of an injection moulding process.

It should be mentioned at this juncture that the definition that the mounting rails each extend integrally over multiple discrete height levels is not intended to preclude the mounting rails from each being connected to additional, separate components or the mounting rails from additionally having such components. This applies in particular to the linear guide means, bearing surfaces, bearing tabs, clamping surfaces and/or clamping tabs mentioned below which can each be components which are integrally connected to the respective mounting rail or alternatively components which are separate from the respective mounting rail. The aforementioned definition should merely be understood to mean that the respective mounting rail forms an integral portion between at least two discrete height levels. The term “integral” should therefore not necessarily be understood with regard to the entire mounting rail and all of its features/components, although the mounting rails may also be completely integral.

The two mounting rails preferably run parallel or at least substantially parallel to one another along their longitudinal extents or their longitudinal axes.

The two mounting rails are preferably spaced apart from one another along a first translational degree of freedom (corresponding to the “width” of the rail arrangement). A second translational degree of freedom preferably defines the insertion and extension direction, also mentioned below, for the carrier unit (corresponding to the “overall depth” of the rail arrangement). The “overall height” of the rail arrangement is preferably assigned to a third translational degree of freedom. Said three translational degrees of freedom are in each case oriented orthogonally to one another according to the customary definition.

The mounting rails can be mountable independently of one another and without mutual connection on the supports of a distribution frame. To this end, the “fastening points” mentioned below can be usable.

Owing to the fact that two mutually independent mounting rails are used for fastening the carrier units in the joint distribution frame, generally every fastening position present in the distribution frame can be used flexibly and populated modularly with any desired carrier units. The storage space in the distribution frame or distribution cabinet can be optimally utilized as a result. At the same time, the diversity of configurations in the distribution frame is maximized.

It is preferably possible to dispense with the use of a housing for the carrier units, for example a carrier housing for a tray or for a patch panel, as a result of which construction space is saved and configuration capability gained. Furthermore, the accessibility for cabling and mounting can be improved when a housing is omitted.

The rail arrangement can be mounted or mountable in the distribution frame in such a way that the first mounting rail is fastened to a first vertical strut and the second mounting rail to a second vertical strut of the distribution frame, said vertical struts preferably being arranged on the same side of the distribution frame (in particular on the front side of the distribution frame).

In the mounted state of the rail arrangement in the distribution frame, the first mounting rail and the second mounting rail are preferably mounted at mounting points (for example screw-connection points arranged in a grid-like manner) of the same height position or height level of the distribution frame.

In the mounted state of the rail arrangement in the distribution frame, the first mounting rail and the second mounting rail are preferably oriented in such a way that the insertion direction and/or extension direction or the aforementioned second translational degree of freedom runs at the same height level or height position of the distribution frame. A movement of the carrier unit guided by the rail arrangement can therefore preferably run at the same height position of the distribution frame, i.e. horizontally or parallel to an installation area of the distribution frame.

However, in the mounted state of the rail arrangement, a vertical guide of the carrier unit can also be provided, i.e. In particular a configuration “hanging” in the distribution frame. In this case, provision can be made that the insertion and extension direction or the aforementioned second translational degree of freedom intersects multiple height levels or height positions of the distribution frame. In this case, the insertion and pull-out direction therefore runs vertically or orthogonally to the installation area of the distribution frame.

A mixed horizontal and vertical insertion and pull-out movement, i.e. an oblique guide of the carrier unit with respect to the installation area of the distribution frame, can also be provided.

Optionally, it is additionally also possible to provide a rotatable or pivotable arrangement of the carrier unit in the rail arrangement, i.e. an additional guide along at least one rotational degree of freedom.

For easier understanding, the invention is described below essentially with reference to the purely horizontal insertion and pull-out direction. However, the following variants and developments are also suitable for a hanging or vertical arrangement or for an oblique arrangement, unless this is technically ruled out.

According to the invention, it is provided that each of the mounting rails has at least one primary linear guide means at each of the height levels, in order to guide the respective carrier unit parallel to a longitudinal axis of the mounting rails (in particular along the aforementioned second translational degree of freedom or in or counter to the insertion direction).

The rail arrangement is therefore capable of guiding the carrier unit in the manner of a drawer, which can permit particularly good accessibility to components of the carrier unit in the mounted state of the rail arrangement. Preferably, but not necessarily, the guidance is effected exclusively in the insertion and extension direction or along the second translational degree of freedom.

The primary linear guide means can be formed integrally from the respective mounting rail or can be connected to the respective mounting rail, or fastened to the respective mounting rail, as a separate component.

According to the invention, it is provided that each of the mounting rails has, at at least one of the height levels, multiple separate bearing surfaces for the primary linear guide means and/or for the respective carrier unit. At least the bearing surfaces of the same height level are spaced apart from one another along the longitudinal axis of the mounting rails.

Owing to the fact that, instead a joint, single bearing surface, multiple separate bearing surfaces, distributed along the longitudinal axis, for the carrier units are provided at the same height level, the mechanical stability of the rail arrangement or the guidance of the carrier units can be optimized by the multiple bearing regions. Furthermore, the production of the mounting rails can be simplified, since multiple small bearing surfaces can be formed instead of one comparatively large bearing surface. This makes it possible in particular to simplify the performance of a stamping and bending process.

In the mounted state of the carrier units in the rail arrangement, provision may be made for the carrier units to rest directly on the respective bearing surfaces. As an alternative, provision may be made for the primary linear guide means to rest directly on the bearing surfaces (preferred). However, it is in particular also possible for a mixed support of carrier unit and primary linear guide means at the same height level to be provided, for example by joint bearing surfaces or a first group of bearing surfaces which are specifically assigned to the carrier units and a second group of bearing surfaces which are specifically assigned to the primary linear guide means.

In particular, the following advantageous variants of the invention can be provided, the following list not being exhaustive:
the primary linear guide means is formed integrally or monolithically with the respective mounting rail; or
the primary linear guide means is in the form of a separate component and rests on the corresponding support surfaces (and is optionally fastened on the support surfaces or to the support tabs), but is not otherwise fastened to the mounting rail; or
the primary linear guide means is in the form of a separate component and is fastened to the side wall of the corresponding mounting rail, but does not rest on the support surfaces; or
the primary linear guide means is in the form of a separate component, rests on the corresponding support surfaces and is additionally also fastened to the side wall of the corresponding mounting rail (preferred variant).

In an advantageous development of the invention, provision may be made for height levels which adjoin one another to be spaced apart from one another by less than one rack unit, preferably to be spaced apart from one another by ⅔ of a rack unit, and very particularly preferably to be spaced apart from one another by ⅓ of a rack unit.

Insofar as a‘rack unit’ is referred to above and below, it is a standardized measurement unit which is typically used for electronics housings, is familiar to a person skilled in the art and is used in particular with respect to device housings for installation in 19 inch racks or 19 inch distribution frames. One rack unit corresponds to 1¾ inches or 44.45 millimetres.

The integral mounting rails proposed according to the invention with the respective bearing surfaces at the discrete height levels makes it possible to achieve a particularly compact arrangement or reception of carrier units, which is why the invention is particularly advantageously suitable for a narrow spacing between the height levels, as proposed above. However, in principle, any spacing between the individual height levels may be provided, possibly also a different spacing between adjacent height arrangements of the same mounting rail in order to receive carrier units of different overall height.

According to one development of the invention, provision may be made for one, multiple or all the bearing surfaces to be formed on respective bearing tabs.

The bearing tabs or the bearing surfaces may each extend in the direction of the opposite mounting rail and partially along the longitudinal axis of the mounting rails. The bearing tabs or the bearing surfaces therefore preferably extend along the first translational degree of freedom and along the second translational degree of freedom.

The extent of the bearing tabs or bearing surfaces in the direction of the opposite mounting rail or along the first translational degree of freedom is preferably greater than the extent along the longitudinal axis of the mounting rails or along the second translational degree of freedom. Elongate bearing tabs can thus preferably be formed, which run in the longitudinal direction towards the respectively opposite mounting rail. The opposite bearing tabs of the mounting rails preferably do not touch—the mounting rails are thus preferably spaced apart from one another in the mounted state.

Preferably, the bearing surfaces run perpendicular to the third translational degree of freedom or extend orthogonally from the side walls of the mounting rails.

As already mentioned above, provision may optionally be made for the carrier units to be pivotable or rotatable in the rail arrangement. Provision may for example be made for one of the carrier units on its own, some of the carrier units together or all the carrier units together to initially be able to be at least partially pulled out of the rail arrangement in the pull-out direction until a pivoting position is reached, with the result that the carrier units are subsequently able to be partially folded downwards. To this end, it is for example possible for at least one of the bearing tabs to be rotatably or pivotably connected to the side wall of the respective mounting rail.

In principle, any number of bearing tabs or bearing surfaces per height level can be provided. Two bearing tabs may possibly also already be sufficient, but preferably more than two bearing surfaces height level are provided, for example three, four, five, six, seven, eight or more bearing surfaces.

In one refinement of the invention, provision may be made for at least one of the bearing tabs of a joint height level to be arranged on a front end portion of the mounting rail and a further bearing tab of the same height level to be arranged on a rear end portion of the mounting rail.

The bearing tabs are preferably formed integrally or monolithically from the respective mounting rail (preferred). The bearing tabs may possibly alternatively be separate components which are connected to the respective mounting rail in a form-fitting, force-fitting and/or materially bonded manner. The separate bearing tabs may, for example, be welded, adhesively bonded, screwed or latched to the respective mounting rail.

According to a preferred development of the invention, provision may be made for one, multiple or all the bearing tabs to be stamped out of a side wall of the corresponding mounting rail and to be bent over in the direction of the opposite mounting rail.

Provision may be made for the at least one bearing tab of the lowest height level of the mounting rail to be exclusively bent over. However, the bearing tab of the lowest height level may possibly also be stamped out first and only then bent over, as has been described with regard to the other bearing tabs.

Provision may in particular be made for only one bearing tab and thus one bearing surface to be formed at the lowest height level of the mounting rail, or at least fewer bearing tabs or fewer bearing surfaces than at the height levels located thereabove. This possibility exists in particular because no stamping out of the mounting rail has to be effected in order to form the bearing tab of the lowest height level.

In one development of the invention, provision may be made for an extent of one, multiple or all the bearing tabs in the direction of the respectively opposite mounting rail to be greater than a distance between the discrete height levels, preferably to be greater than ⅓ of a rack unit, possibly even to be greater than ⅔ of a rack unit or to be greater than one rack unit.

This makes it possible to provide a particularly great extent of the bearing surface along the first translational degree of freedom, with the result that the corresponding carrier units are stably supported and particularly well protected against tilting.

In one development of the invention, provision may be made for at least or in particular the bearing tabs of in each case two directly adjacent height levels of the same mounting rail to be arranged spaced apart from one another along the longitudinal axis of the mounting rail.

Particularly in this development, the extent of the bearing tabs of adjacent height levels along the first translational degree of freedom can therefore be greater than the distance between the discrete height levels. It is thus possible for the stamping region (that is to say for example a window-like cutout in the side wall of the mounting rail), out of which the corresponding bearing tab has been stamped, to extend along the side wall of the mounting rail over more than one height level, without colliding with a further stamping region or a bearing tab of the adjacent height level(s).

In an advantageous development of the invention, provision may be made for the at least one primary linear guide means to be in the form of a component which is separate from the respective mounting rail.

The at least one primary linear guide means may be fastened, preferably (but not necessarily) fastened so as to be detachable without being destroyed, to the respective mounting rail. To this end, it is for example possible to provide a latching connection or a screw connection. However, in principle, any form-fitting, force-fitting and/or materially bonded connection may be suitable.

A multi-part design offers particularly great design freedom and and can in particular also increase the flexibility of the reduction method of the rail arrangement, since materials and production methods which may differ for the mounting rail and for the primary linear guide means and are particularly suitable for the respective component can be used.

In a preferred refinement, the primary linear guide means may be formed from a plastic. It is thus for example possible for the primary linear guide means to be producible by an injection moulding process and the mounting rail by a stamping and bending process. It should be mentioned at this juncture that the primary linear guide means may possibly also be formed from a metal component or from a combination of metal and plastic.

In one development of the invention, provision may be made for each of the mounting rails to have, for each height level, at least one clamping surface which is arranged above the bearing surfaces of the same height level, in order to receive the respective primary linear guide means and/or the respective carrier unit between the bearing surfaces and the at least one clamping surface.

The clamping surfaces and the clamping tabs mentioned below can in principle be formed in the manner already described with regard to the bearing surfaces and bearing tabs. Features and advantages mentioned above for the bearing surfaces and the bearing tabs can therefore also be transferred to the clamping surfaces and the clamping tabs mentioned below—and vice versa.

Provision may in particular be made for one, multiple or all the clamping surfaces to be formed on respective clamping tabs which are bent over and have preferably (but not necessarily) previously been stamped out of a side well of the mounting rail.

Provision may be made for the at least one clamping tab of the uppermost height level to be exclusively bent over.

The combination of clamping surface and bearing surface fundamentally makes it possible to provide, per height level, a kind of guide channel or a clamping channel for the carrier unit and/or for the primary linear guide means, making it possible to prevent tilting of carrier unit and/or primary linear guide means in the mounted state or during the insertion or extension.

Provision may be made for the extent of the clamping surfaces or clamping tabs in the direction of the respectively opposite mounting rail (i.e. along the first translational degree of freedom) to be smaller than the extent of the bearing surfaces or bearing tabs. The clamping surfaces can thus preferably be shorter than the bearing surfaces.

It should be mentioned at this juncture that combined bearing and clamping tabs may also be provided instead of separate bearing tabs and clamping tabs, wherein the bearing surface can be formed on the top side, and the clamping surface on the bottom side facing away from the top side, of the same bearing and clamping tab. However, a more flexible and more precise rail arrangement can generally be realized through the use of separate bearing tabs and clamping tabs.

In an advantageous development of the invention, provision can be made for the primary linear guide means to have front-side and/or rear-side movement limiting means, in order to limit the linear movement of the carrier unit.

It is thus possible to prevent the carrier unit from unintentionally being slid into the distribution frame or being slid out of the rail arrangement on the rear side. As an alternative or in addition, provision may also be made for the first mounting rail and/or the second mounting rail to have a front-side movement limiting means, in order to limit the movement of the carrier unit at least counter to the insertion direction, with the result that the carrier unit cannot be unintentionally completely slid out of the distribution frame or out of the rail arrangement towards the front.

The front-side or rear-side movement limiting means may optionally be detachable or unlockable without being destroyed as required, for example through actuation of the unlocking lever mentioned below.

The movement limiting means may preferably be designed as a constituent part of the primary linear guide means (for example as an elastic plastic lug). However, the movement limiting means may also be formed integrally with the mounting rail, for example as a formed sheet metal portion.

Preferably, the movement limiting means is designed to be at least partially elastic in or counter to the insertion direction and has, for example, a spring, in particular a leaf spring. In addition to the limiting of the insertion depth, that is to say in addition to a fixing or stopper function, the movement limiting means can thus at least assist the sliding of the carrier unit out of the rail arrangement in the pull-out direction (i.e. counter to the insertion direction) for example push the carrier unit forwards until an unlocking, for example an unlocking of the unlocking element or unlocking lever mentioned below, is actuated by the service engineer.

Provision may preferably be made for the primary linear guide means to have an unlocking element for the movement limiting means, for example an unlocking lever arranged on the front side or rear side.

In an advantageous development of the invention, provision may be made for the mounting rails to each have means for increasing the mechanical rigidity.

In this way, it is possible to design the mounting rails for example as thin sheet metal parts and to subsequently stiffen them, making it possible to further reduce the material costs for the production of the mounting rails.

For example, the mounting rail may have one or more folded-over edges, struts or material reinforcements formed along the longitudinal axis of the mounting rail, in order to increase the mechanical rigidity. In principle, any arbitrary strengthening measures can be provided, in order to increase the mechanical rigidity. In particular, the use of a material assembly composed of at least two basic materials can also be provided, for example a metal/plastic combination or a combination of various metals or plastics in the same mounting rail.

In one development of the invention, provision may be made for each of the mounting rails to have at least one fastening point for fastening to a distribution frame.

Provision may in particular be made for the at least one fastening point of the first mounting rail and/or of the second mounting rail to be arranged on an end portion of the respective mounting rail. The end portion may, for example, be provided at a front end of the mounting rail in the pull-out direction.

Provision may in particular be made for the end portion having the fastening point to run transversely or orthogonally with respect to the insertion/pull-out direction of the carrier unit, for example in the form of a tab or lug. However, the fastening point may for example also be formed on a side surface of the mounting rail.

The mounting rail can subsequently be positioned with its at least one fastening point, in particular a cutout, at the provided fastening position or height level of the distribution frame and be fastened to the distribution frame by way of a fastening means (for example a screw, a bolt and/or a cage nut). The fastening means may be formed integrally with the mounting rail or the distribution frame—but is preferably a separate component.

For example, the fastening point of the mounting rail may be in the form of a bore, preferably in the form of an oversized bore or in the form of an elongate hole. An elongate hole or an oversized bore makes it possible to ensure that no undesired height offset is produced between the two mutually independent mounting rails and mounting tolerances during the fastening in the distribution frame and tolerances of the distribution frame and of the mounting rails can be compensated.

The fastening point may also be in the form of a projection, for example pin, web or threaded pin, in order to fasten the mounting rail directly in a cutout in the distribution frame. Provision may also be made for the fastening point to have a snap-fit connection.

The mounting rails are preferably fastenable to a front side of the distribution frame, in particular from the front. However, in principle, a fastening for example to the rear side of the distribution frame is also possible (as an alternative or in addition) or a fastening in a central portion of the distribution frame (once again as an alternative or in addition).

The in each case at least one fastening point makes it possible for each mounting rail to be mountable at a suitable fastening position of the distribution frame. To this end, the distribution frame preferably has, at defined height positions or height levels which are discretely spaced apart from one another, corresponding fastening positions for the individual mounting rails. The fastening positions of the distribution frame are preferably each spaced apart from one another by one third of a rack unit.

Each of the mounting rails preferably has at least two fastening points which are spaced apart from one another and arranged at different height levels. For example, a first one of the fastening points may be formed at the lowest height level provided by the mounting rail and a second one of the fastening points may be formed at the uppermost height level provided by the mounting rail, in order to ensure a particularly stable fastening to the distribution frame.

It should be mentioned at this juncture that a “distribution frame” can in particular be a complete frame or a complete carrier construction, as is known, for example, in the case of 19 inch racks. The distribution frame may thus, for example, have at least four vertical struts which, in a top view, form the corners of a rectangle, with the result that a receiving region for the rail arrangement or for the carrier arrangement is formed between the vertical struts. However, in the context of the invention, a distribution frame should also already be understood to mean an arrangement of fewer than four vertical struts, that is to say for example a triangular arrangement, in plan view, of three vertical struts or an arrangement of only two vertical struts spaced apart from one another.

The distribution frame may optionally also have horizontal struts or transverse struts which connect the vertical struts to one another. However, in particular in a minimalistic version of the distribution frame, provision may be made for the distribution frame to consist exclusively of two vertical struts which are optionally connectable to a surrounding structure, such as a building wall, in order to ensure sufficient stability. The proposed rail arrangement can, in principle, be usable with all conceivable and aforementioned variants of a distribution frame.

In an advantageous development of the invention, provision may be made for the first mounting rail and the second mounting rail to have the same structural design, but be formed and arranged mirror-symmetrically with respect to one another.

Provision may optionally be made for at least one of the mounting rails to have a portion for the direct or indirect fastening of fibre-optic distribution heads. This fastening portion can preferably be formed on an end portion or end of the mounting rail, in particular on an end portion bent over in a lug-like manner.

The Invention also relates to a carrier arrangement, having multiple carrier units, in particular patch panels or trays, and a rail arrangement for the carrier units according to the embodiments above or below, wherein the carrier units are received between the two mounting rails (preferably connected directly to the two mounting rails) so as to be distributed among the different height levels.

Preferably, the carrier units are received between the mounting rails in such a way that the carrier units are movable along at least one translational degree of freedom, in particular in the insertion and pull-out direction (second translational degree of freedom) already mentioned above.

The use of separate mounting rails in the proposed carrier arrangement makes it possible to provide very good accessibility to the carrier units or to the interior of the distribution frame on account of the carrier units which preferably do not have housings. At the same time, a particularly modular combination of different types and height variants of carrier units becomes possible.

According to one development of the invention, provision may be made for in each case at least one secondary linear guide means to be arranged along those side parts of the carrier units which face towards the mounting rails. The secondary linear guide means may form, with the respectively assigned primary linear guide means of the mounting rails, a linear guide for the respective carrier unit along the longitudinal axis of the mounting rails.

Provision may in particular be made for the primary linear guide means to be in the form of sliding blocks and the secondary linear guide means to be in the form of corresponding guide grooves—or vice verse. It is for example also possible for a T groove connection or a dovetail connection to be realized.

The linear guide pair of primary linear guide means and secondary linear guide means can preferably provide a linear guide in the insertion and pull-out direction, but possibly also orthogonally with respect thereto, in particular in a vertical direction or along the third translational degree of freedom. A linear guide in the vertical direction can advantageously assist insertion of the carrier unit into the rail arrangement.

The linear guide pair is able to provide security against loss because of an additional form fit between mounting rail and carrier unit and also to mechanically stabilize the guide.

The Invention also relates to a fibre-optic distribution system, having a distribution frame and at least one carrier arrangement according to the embodiments above and below.

Insofar as multiple carrier arrangements are provided within the distribution frame, they are fastened preferably at different height levels in the distribution frame and/or are arranged in a hanging arrangement in the distribution frame.

Provision may be made to mount two, three, four, five, six, seven, eight, nine, ten, twenty, thirty, forty, fifty or even more carrier arrangements at different height positions, preferably directly one above another, in a joint distribution frame. In particular, such a stack of multiple carrier arrangements (registers) or the rail assembly can be successively constructed. The distribution frame can be populated as desired with carrier units, in particular patch panels or carrier arrangements.

The small overall height of the mounting rails or carrier arrangements makes it possible to produce a very fine height division, with individual carrier units being able to act as a covering for other carrier units in order, in the non-pulled-out state, to limit the access to the fiber-optic infrastructure to the most necessary, and to prevent dust and soiling.

Optionally, a separate cover or a separate covering (e.g. a metal plate) or a dummy carrier unit or a dummy patch panel can be provided for the uppermost carrier unit or the uppermost carrier arrangement of the stack/the rail assembly. In principle, a cover or a separate covering, in particular a metal plate, can be provided for any desired carrier unit of the stack, i.e. not necessarily only for the uppermost carrier unit.

In an advantageous manner, standardized carrier units of differing functionality (for example module carriers, cable management systems, storage solutions or labeling panels) can be combined with one another as desired in the overall assembly in a joint distribution frame and, even after mounting in the distribution frame, can be exchanged and modified independently of one another. In this way, customer enquiries can be dealt with extremely specifically without having to produce an individual product for the particular application.

Preferably, neither the rail arrangement, the carrier arrangement, the distribution frame nor the fiber-optic distribution system have a carrier housing. A patch panel without a carrier housing is sometimes also referred to as a “tray”.

Features which have been described in connection with one of the subjects of the invention, which are specifically the rail arrangement according to the invention, the carrier arrangement or the fibre-optic distribution system, can also be advantageously applied to the other subjects of the invention. Likewise, advantages specified in connection with one of the subjects of the invention can also be understood in relation to the other subjects of the invention.

In addition, it should be noted that expressions such as “comprising”, “having” or “with” do not exclude any other features or steps. Furthermore, expressions such as “a” or the that refer in the singular to steps or features do not exclude a plurality of features or steps—and vice versa.

In a puristic embodiment of the invention, it may however also be provided that the features introduced in the invention by the expressions “comprising”, “having” or “with” constitute an exhaustive list. Accordingly, in the context of the invention, one or more lists of features can be considered in self-contained form, for example respectively for each claim. By way of example, the invention can consist exclusively of the features specified in claim 1.

Note that terms such as “first” or “second” etc. are used predominantly for the sake of distinguishability between respective device or method features, and are not imperatively intended to indicate that features are mutually dependent or relate to one another.

It is furthermore emphasized that the values and parameters described in the present case also encompass deviations or fluctuations of ±10% or less, preferably ±5% or less, more preferably ±1% or less, and very particularly preferably ±0.1% or less, of the respectively stated value or parameter, if such deviations are not ruled out in practice in the implementation of the invention.

The specification of ranges by way of start and end values also encompasses all values and fractions encompassed by the respectively stated range, in particular the start and end values and a respective mean value.

The invention also relates to a further rail arrangement, independent of claim 1, for receiving multiple carrier units for fibre-optic components, in particular for patch panels. This further rail arrangement has a first mounting rail and a separate second mounting rail, wherein the mounting rails are spaced apart from one another and each extend over multiple discrete height levels (preferably, but not necessarily integrally), in order to receive the carrier units between them so as to be distributed among the height levels, wherein each of the mounting rails has, at at least one of the height levels, multiple separate bearing surfaces which are spaced apart from one another along the longitudinal axis of the mounting rails. In particular, a primary linear guide means is merely optional in the further rail arrangement described here. The carrier units and/or the (optional) primary linear guide means can rest on the bearing surfaces in the mounted state—but this is not strictly necessary. The further features of claim 1 and of the dependent claims, and the features described in the present description, relate to advantageous embodiments and variants of this further rail arrangement and the applicant explicitly reserves the right to claim the further rail arrangement described here independently of patent claim 1. The applicant also reserves the right to claim a carrier arrangement in the manner of claim 13 and a fibre-optic distribution system in the manner of claim 15 on the basis of the further rail arrangement described here.

Exemplary embodiments of the invention will be described in more detail below with reference to the drawings.

The figures each show preferred exemplary embodiments in which individual features of the present invention are illustrated in combination with one another. Features of one exemplary embodiment may also be implemented separately from the other features of the same exemplary embodiment, and may accordingly be readily combined by a person skilled in the art to form further useful combinations and sub-combinations with features of other exemplary embodiments.

Elements of identical function are denoted by the same reference signs in the figures.

In the figures, in each case schematically:

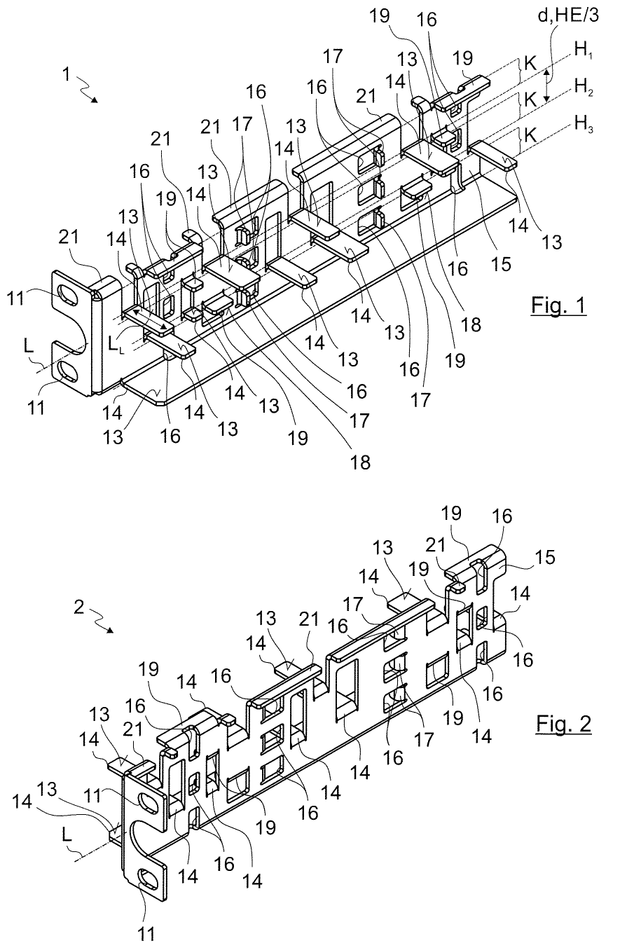

FIG. 1 shows a first mounting rail of a rail arrangement according to a first exemplary embodiment in a perspective view;

FIG. 2 shows a second mounting rail of a rai arrangement according to the first exemplary embodiment in a perspective view;

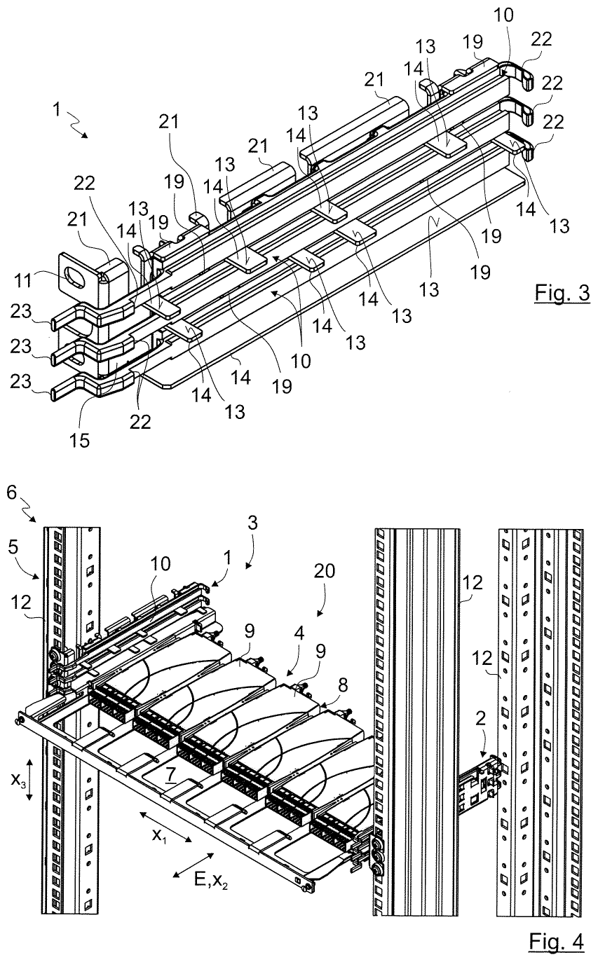

FIG. 3 shows the first mounting rail according to FIG. 1 with three linear guide means connected to the mounting rail in a perspective view;

FIG. 4 shows a fibre-optic distribution system according to the invention with a distribution frame and a carrier arrangement composed of a rail arrangement according to the first exemplary embodiment and of a carrier unit received in the rail arrangement;

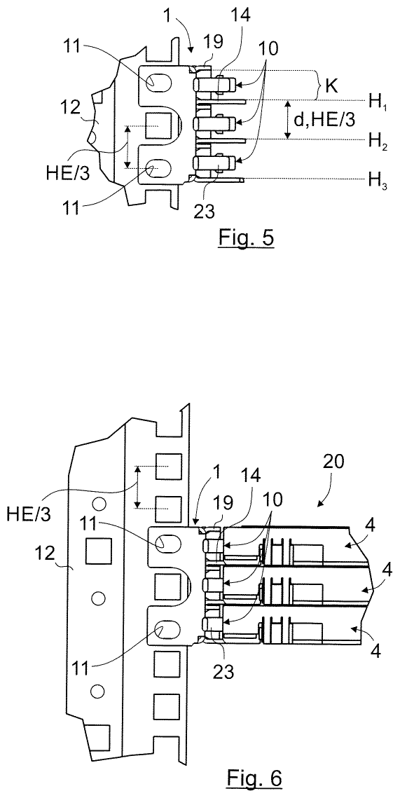

FIG. 5 shows a partial enlarged front view of a first mounting rail according to FIG. 3 mounted in the distribution frame;

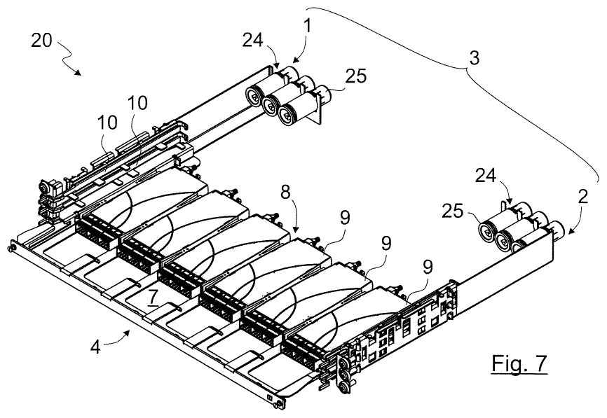

FIG. 6 shows a partial enlarged front view of a fully populated carrier arrangement received in the distribution frame; and

FIG. 7 shows a rail arrangement of the invention according to a further exemplary embodiment.

FIG. 1 shows a first mounting rail 1 and FIG. 2 a second mounting rail 2 according to an exemplary embodiment of a rail arrangement 3 according to the invention (f. FIG. 4) for receiving multiple carrier units 4 (cf. also FIG. 4) for fibre-optic components. In the exemplary embodiments, the carrier units 4 are each in the form of patch panels, but this should not be understood as limiting. The rail arrangement 3 can, in principle, be suitable for use with any desired carrier units 4, in particular even for use with trays or dummy elements.

The rail arrangement 3 illustrated in FIG. 4 in a mounted state within a distribution frame 5 of a fibre-optic distribution system 8 has the two mounting rails 1, 2 already mentioned, wherein the mounting rails 1, 2 are spaced apart from one another (along a first degree of freedom x₁) and each extend integrally along a third degree of freedom x₃ over multiple discrete height levels H₁, H₂, H₃ (cf. FIG. 1). This makes it possible for the carrier units 4 to be received between the mounting rails 1, 2 so as to be distributed among the height levels H₁, H₂, H₃. By way of example, FIG. 4 illustrates a carrier unit 4 mounted at the lowest height level H₃ of the rail arrangement 3.

The carrier unit 4 in the form of a patch panel has a front interface or connection panel 7 and a rear interface 8. Multiple cassettes 9 which can each have optical and/or optical-electrical plug connectors are arranged in the carrier unit 4. Such patch panels are known in principle and are available in many different variants, and therefore more specific details will not be discussed in the present case.

In the exemplary embodiments, the rail arrangement 3 is designed to movably guide the carrier unit 4 or patch panel along and counter to an insertion direction E (or along a second translational degree of freedom x₂ orthogonally with respect to the first translational degree of freedom x₁). To this end, the rail arrangement 3 has, for each of the mounting rails 1, 2, at each height level H₁, H₂, H₃, a primary linear guide means 10 which is connected to the respective mounting rail 1, 2 (cf. In particular FIG. 3). Accordingly, in each case corresponding secondary linear guide means are arranged along those sides of the carrier units 4 which face towards the mounting rails 1, 2 (not illustrated in the figures). The secondary linear guide means form, with the respectively assigned primary linear guide means 10 of the mounting rails 1, 2, a linear guide for the respective carrier unit 4 along the longitudinal axis L of the mounting rails 1, 2. To this end, the primary linear guide means 10 are by way of example in the form of sliding blocks, wherein the secondary linear guide means can accordingly form corresponding guide grooves—or vice versa.

In the exemplary embodiments, the first mounting rail 1 and the second mounting rail 2 each have the same structural design, but are formed and arranged mirror-symmetrically with respect to one another. Each of the mounting rails 1, 2 has at least one fastening point 11, in the exemplary embodiments in each case two fastening points 11, for fastening to the distribution frame 5. For this purpose, the fastening points 11 are arranged at different height levels H₁, H₂, H₃ of respective bent-over, lateral portions (lugs) of the respective mounting rail 1, 2. The fastening points 11 are realized as elongate bores in order to create a compensation option for tolerances. These fastening points 11 or elongate bores can be finally arranged in alignment with the desired mounting points of the distribution frame 5 or with the mounting points of the vertical strut 12, provided for the fastening, of the distribution frame 5 (f. FIGS. 4 to 6), and therefore the first mounting rail 1 and the second mounting rail 2 are preferably each fastened at the same height positions in the distribution frame 5.

As a rule, the height positions or the fastening points of the distribution frame 5 are arranged in a defined grid and are each spaced apart from one another by one third of a rack unit U. Preferably, the height levels H₁, H₂, H₃ which adjoin one another of the rail arrangement 3 or of the mounting rails 1, 2 are spaced apart from one another by less than one rack unit U, preferably are spaced apart from one another by ⅔ of a rack unit U, and very particularly preferably are spaced apart from one another by ⅓ of a rack unit U.

It is proposed that each of the mounting rails 1, 2 has, at at least one of the height levels H₁, H₂, H₃, multiple separate bearing surfaces 13 for the primary linear guide means 10 and/or for the respective carrier unit 4. In this case, the bearing surfaces 13 of the same height level H₁, H₂, H₃ are each spaced apart from one another along the longitudinal axis L of the mounting rails 1, 2. In the exemplary embodiments, the bearing surfaces 13 are each formed on bearing tabs 14 which extend in the direction of the opposite mounting rail 1, 2 and partially along the longitudinal axis L of the mounting rails 1, 2. The bearing tabs 14 can for example be realized by virtue of them being stamped out of a side wall 15 of the corresponding mounting rail 1, 2 and bent over in the direction of the opposite mounting rail 1, 2. The bearing tab 14 of the lowest height level H₃ may also be only exclusively bent over, as shown in the exemplary embodiments. Possibly even only one bearing tab 14 or one bearing surface 13 may be provided at the lowest height level H₃ of the respective mounting rail 1, 2. By contrast, the bearing surfaces 13 for the further height levels H₁, H₂, H₃ are by way of example formed by each case four bearing tabs 14 which are arranged distributed along the longitudinal axis L of the mounting rails 1, 2.

It has been shown that particularly high mechanical stability can be achieved when the longitudinal extent L of the bearing tabs 14 in the direction of the respectively opposite mounting rail 1, 2 is greater than a distance d between the discrete height levels H₁, H₂, H₃, preferably is greater than ⅓ of a rack unit U (cf. FIG. 1). In this respect, provision is made in the exemplary embodiment for the bearing tabs 14 of in each case two directly adjacent height levels H₁, H₂, H₃ of the same mounting rail 1, 2 to be arranged spaced apart from one another along the longitudinal axis L of the mounting rail 1, 2. In this way, a stamped-out region (stamping region) can extend over multiple height levels H₁, H₂, H₃, without colliding with a stamping region or a bearing tab 14 of the adjoining height level H₁, H₂, H₃.

The primary linear guide means 10 already mentioned above is in the form of a component which is separate from the respective mounting rail 1, 2, and is fastened to the respective mounting rail 1, 2. This fastening is preferably effected so as to be detachable without being destroyed, for example by way of a latching connection or a screw connection. To this end, in the exemplary embodiments, fastening cutouts 16 and fastening tabs 17 are formed in the side wall of the respective mounting rail 1, 2 and can enable latching of corresponding counterpart fastening means (not illustrated) of the primary linear guide means 10.

In order to allow the carrier units 4 and/or primary linear guide means 10 to be fastened in the rail arrangement 3 in a manner that is even more stable mechanically and in particular to prevent lateral tilting, provision may be made for each of the mounting rails 1, 2 to have, for each height level H₁, H₂, H₃, at least one clamping surface 18 which is arranged above the bearing surfaces 13 of the same height level H₁, H₂, H₃. In this way, the respective primary linear guide means 10 and/or the respective carrier unit 4 can be received between the bearing surfaces 13 and the clamping surfaces 18. In the exemplary embodiments, the damping surfaces 18 are also formed on respective bent-over clamping tabs 19, which may optionally be stamped out but possibly (cf. uppermost height level H₁) also exclusively bent over. Between the clamping surfaces 18 and the bearing surfaces 13, a clamping channel K is thus formed for each height level H₁, H₂, H₃ (cf. FIG. 1).

In order to further illustrate the clamping or support by way of the clamping surfaces 18 and bearing surfaces 13, FIG. 5 shows a front view of the rail arrangement 3 in a mounted state within the distribution frame 5. It is readily apparent here that the primary linear guide means 10 are each received between the clamping tabs 19 and the bearing tabs 14. FIG. 6 shows the same rail arrangement 3 in its mounted state on the distribution frame 5 as part of a carrier arrangement 20 together with the mounted patch panels or carrier units 4, which are received between the two mounting rails 1, 2 so as to be distributed among the different height levels H₁, H₂, H₃.

Provision may be made for the mounting rails 1, 2 to each have means for increasing the mechanical rigidity. These may for example be folded-over edges 21 formed along the longitudinal axis L of the mounting rail 1, 2 (cf., inter alia, FIG. 1). The folded-over edges 21 serving to increase the mechanical rigidity may possibly also be identical to bearing tabs 14 and/or clamping tabs 19.

As can be particularly readily seen with reference to FIG. 3, the primary linear guide means has front-side and rear-side movement limiting means 22, in order to limit the linear movement of the carrier unit 4. By way of example, an unlocking element 23 in the form of an unlocking lever is illustrated for the front-side movement limiting means 22.

As already mentioned, FIG. 4 shows a fibre-optic distribution system 6 composed of a distribution frame 5 and of one of the carrier arrangements 20 described above which is fastened in the distribution frame 5. In principle, any desired number of carrier arrangements 20 can be provided in the distribution frame 5.

FIG. 7 also shows an advantageous development of the proposed carrier arrangement 20, in which the mounting rails 1, 2 of the rail arrangement 3 have, on their rear-side end portion, fastening regions 24 for the fastening of fibre-optic distribution heads 25.

1. A rail arrangement (3) for receiving carrier units (4) for fibre-optic components, the rail arrangement (3) comprising:
a first mounting rail (1) that defines a longitudinal axis (L); and
a second mounting rail (2) that is separate from, and spaced apart from, the first mounting rail (1) and the second mounting rail (2) defines a longitudinal axis (L); and wherein
the first and second mounting rails (1, 2) each extend over multiple discrete height levels (H₁, H₂, H₃), so as to receive the carrier units (4) at one of the multiple discrete height levels (H₁, H₂, H₃); and wherein
each of the first and second mounting rails (1, 2) has, at each of the multiple discrete height levels (H₁, H₂, H₃), at least one primary linear guide means (10) to guide the respective received carrier unit (4) parallel to the longitudinal axis (L) of each of the first and second mounting rails (1, 2); and wherein
each of the first and second mounting rails (1, 2) has a bearing surface (13) for the primary linear guide means (10), or for the received carrier unit (4), at one of the multiple discrete height levels (H₁, H₂, H₃); and wherein
the bearing surfaces (13) of the first and second mounting rails (1, 2) are spaced apart from one another along the longitudinal axis (L) of the first mounting rail (1) and along the longitudinal axis (L) of the second mounting rail (2); and wherein
one, multiple or all of the bearing surfaces (13) are formed on respective bearing tabs (14).

2. The rail arrangement (3) as claimed in claim 1 and wherein the multiple discrete height levels (H₁, H₂, H₃) which are adjacent one another are spaced apart from one another by less than one rack unit (U).

3. The rail arrangement (3) as claimed in claim 1 and further comprising:
bearing tabs (14) carried by the first and second mounting rails (1, 2) and the bearing tabs (14) each extend in a direction toward the opposite mounting rail (1, 2) and partially along the longitudinal axis (L) of the respective mounting rail (1, 2); and
the bearing surfaces (13) are formed on the respective bearing tabs (14).

4. The rail arrangement (3) as claimed in claim 1 and wherein at least one bearing tab (14) is stamped out of a side wall (15) of the corresponding first or second mounting rail (1, 2) and the at least one stamped bearing tab (14) is bent over in a direction toward the opposite mounting rail (1, 2).

5. The rail arrangement (3) as claimed in claim 1 and wherein an extent (L_{L}) of one bearing tabs (14) in a direction toward the opposite first or second mounting rail (1, 2) is greater than a distance (d) between the multiple discrete height levels (H₁, H₂, H₃).

6. The rail arrangement (3) as claimed in claim 1 and wherein the bearing tabs (14) of two directly adjacent height levels (H₁, H₂, H₃) of the multipole discrete height levels (H₁, H₂, H₃) of the same mounting rail (1, 2) are spaced apart from one another along the longitudinal axis (L) of the respective first or second mounting rail (1, 2).

7. The rail arrangement (3) as claimed in claim 1 and wherein the at least one primary linear guide means (10) is separate from the respective first or second mounting rail (1, 2), and is releasably fastened to the respective first or second mounting rail (1, 2).

8. The rail arrangement (3) as claimed in claim 1 and further comprising:
at least one clamping surface (18) on each of the first and second mounting rails (1, 2) at each of the multiple discrete-height levels (H₁, H₂, H₃); and wherein
the at least one clamping surface (18) is above the respective bearing surface (13) of the same multiple discrete height level (H₁, H₂, H₃), in order to receive the respective primary linear guide means (10) of to receive the respective carrier unit (4) between the bearing surfaces (13) and the at least one clamping surface (18); and wherein
the clamping surfaces (18) are formed on respective bent-over clamping tabs (19).

9. The rail arrangement (3) as claimed in claim 1 and further comprising:
movement limiting means (22) on the primary linear guide means (10), to limit linear movement of the carrier unit (4) relative to the primary linear guide means (10); and
an unlocking element (23) for the movement limiting means (22).

10. The rail arrangement (3) as claimed in claim 1 and wherein the first and second mounting rails (1, 2) each have folded-over edges (21) along the longitudinal axis (L) of the respective first or second mounting rail (1, 2) to increase mechanical rigidity of the respective first or second mounting rail (1, 2).

11. The rail arrangement (3) as claimed in claim 1 and wherein the first mounting rail (1) and the second mounting rail (2) have the same structural design, and are formed and arranged mirror-symmetrically with respect to one another.

12. The rail arrangement (3) as claimed in claim 1 and wherein each of the first and second mounting rails (1, 2) has a fastening point (11) for fastening the respective first and second mounting rails (1, 2) to a distribution frame (5).

13. A carrier arrangement (20) comprising:
multiple carrier units (4); and
a rail arrangement (3) for the multiple carrier units (4), the rail arrangement (3) having
a first mounting rail (1) that defines a longitudinal axis (L), and
a second mounting rail (2) that is separate from, and spaced apart from, the first mounting rail (1) and the second mounting rail (2) defines a longitudinal axis (L), and
the first and second mounting rails (1, 2) each extend over multiple discrete height levels (H₁, H₂, H₃), so as to receive at least one of the multiple carrier units (4) at one of the multiple discrete height levels (H₁, H₂, H₃), and
each of the first and second mounting rails (1, 2) has, at each of the discrete height eels (H₁, H₂, H₃), at least one primary linear guide means (10) to guide the respective received carrier unit (4) parallel to the longitudinal axis (L) of each of the first and second mounting rails (1, 2), and
each of the first and second mounting rails (1, 2) has a bearing surface (13) for the primary linear guide means (10), or for the received carrier unit (4), at one of the multiple discrete height levels (H₁, H₂, H₃), and
the bearing surfaces, of the first and second mounting rails (1, 2) are spaced apart from one another along the longitudinal axis (L) of the first and second mounting rails (1, 2); and
the multiple carrier units (4) are received between the first and second mounting rails (1, 2) so as to be distributed among multiple discrete different height levels (H₁, H₂, H₃); and wherein
one, multiple or all the bearing surfaces (13) are formed on respective bearing tabs (14).

14. The carrier arrangement (20) as claimed in claim 13 and further comprising:
a secondary linear guide means along these side parts of the multiple carrier units (4) and the secondary linear guide means face towards the first and second mounting rails (1, 2); and wherein
the secondary linear guide means form, with the primary linear guide means (10) of the first and second mounting rails (1, 2), a linear guide for the respective one of the multiple carrier units (4) along the respective longitudinal axis (L) of the first and second mounting rails (1, 2); and wherein
the primary linear guide means (10) are in the form of sliding blocks, and the secondary linear guide means are in the form of corresponding guide grooves.

15. A fibre-optic distribution system (6) comprising:
a distribution frame (5); and
a carrier arrangement (20), the carrier arrangement (20) having
multiple carrier units (4), and
a rail arrangement (3) for the multiple carrier units (4), the rail arrangement (3) having
a first mounting rail (1) that defines a longitudinal axis (L), and
a second mounting rail (2) that is separate from, and spaced apart from, the first mounting rail (1) and the second mounting rail (2) defines a longitudinal axis (L), and
the first and second mounting rails (1, 2) each extend over multiple discrete height levels (H₁, H₂, H₃), so as to receive at least one of the multiple carrier units (4) at one of the multiple discrete height levels (H₁, H₂, H₃), and
each of the first and second mounting rails (1, 2) has, at each of the discrete height levels (H₁, H₂, H₃), at least one primary linear guide means (10) to guide the respective received carrier unit (4) parallel to the longitudinal axis (L) of each of the first and second mounting rails (1, 2), and
each of the first and second mounting rails (1, 2) has a bearing surface (13) for the primary linear guide means (10), or for the received carrier unit (4), at one of the multiple discrete height levels (H₁, H₂, H₃), and
the bearing surfaces of the first and second mounting rails (1, 2) are spaced apart from one another along the longitudinal axis (L) of the first and second mounting rails (1, 2); and
the multiple carrier units (4) are received between the first and second mounting rails (1, 2) so as to be distributed among multiple discrete different height levels (H₁, H₂, H₃); and wherein
the carrier arrangement (20) is fastened in the distribution frame (5); and wherein
one, multiple or all the bearing surfaces (13) are formed on respective bearing tabs (14).

16. The rail arrangement as claimed in claim 1 and wherein the at least one of the fibre-optic components is a patch panel.

17. The rail arrangement as claimed in claim 1 and wherein each of the first and second mounting rails (1, 2) has multiple bearing surfaces (13).

18. The rail arrangement (3) as claimed in claim 1 and wherein the multiple discrete height levels (H₁, H₂, H₃), which are adjacent one another, are spaced apart from one another by ⅓ of a rack unit (U).

19. The rail arrangement (3) as claimed in claim 3 and wherein an extent (L_{L}) of one bearing tab (14) in a direction toward the opposite first or second mounting rail (1, 2) is greater than ⅓ of a rack unit (U).

20. The rail arrangement (3) as claimed in claim 1 and wherein the at least one primary linear guide means (10) is separate from the respective first or second mounting rail (1, 2), and is fastened thereto so as to be detachable therefrom without being destroyed; and
the at least one primary linear guide means (10) is fastened thereto by a latching connection or by a screw connection.

21. The rail arrangement (3) as claimed in claim 1 and further comprising:
two fastening points (11) on each of the first and second mounting rails (1, 2) for fastening the respective first and second mounting rail (1, 2) to a distribution frame (5); and
the two fastening points (11) are spaced apart from one another and are arranged at different multiple discrete height levels (H₁, H₂, H₃).

22. The carrier arrangement (20) as claimed in claim 13 and wherein the multiple carrier units (4) are patch panels.

23. The rail arrangement (3) as claimed in claim 3 and wherein the bearing tab (14) at a lowest of the multiple discrete height levels (H₃) is exclusively bent over.
